(19) United States
(12) Patent Application Publication
(10) Pub. No.: US 2016/0267578 A1
(43) Pub. Date: Sep. 15, 2016

(54) System and method for implementation of sharing economy in a web environment

(71) Applicant: Svetoslav Lazarov Gramenov, Varna (BG)

(72) Inventor: Svetoslav Lazarov Gramenov, Varna (BG)

(21) Appl. No.: 14/656,755

(22) Filed: Mar. 13, 2015

(51) Int. Cl. G06Q 30/06; H04L 29/08

(52) U.S. Cl. CPC G06Q 30/0645; H04L 67/1097; H04L 67/12

(57) ABSTRACT

The invention provides a method for information exchange in the process of electrical appliance lease. Appliances available for lease are registered in a cloud environment where each appliance is associated with the following information: type (what kind of appliance it is), owner (who is the lessor), holder (who is the current holder), status (is the appliance available for lease), condition (current condition of the appliance), price (lease price of the appliance), rating (rating of appliance) and location (GPS data). Users interact with each other through a server which operates the system. The server receives and executes user action requests, transfers information between users and measures lease time and total price. The server is coupled to a database used for storing data for appliances, users and lease contacts. The processed data is shared in a cloud storage, accessible to the users.

### BACKGROUND

1. Field of Invention

The current disclosure relates generally to the operation of a sharing economy for electrical appliances implemented in a web environment and specifically to the exchange of information regarding electrical appliances with installed GPS tracking chips.

2. Description of the Related Art

A sharing economy or economy of sharing is a system which connects customers in a peer-to-peer basis in order to make better use of underutilized assets. Such assets may be of any kind—a car, a house, an electrical appliance, etc. On one hand such systems offers its members the choice of whether to acquire a certain asset or lease it from another user of the system if such is available. On the other hand owners of idle capital in the form of underutilized assets can profit from it by sharing it with the community. The biggest obstacle to the implementation of a sharing economy system is creating an information environment which contains data for all users and all assets participating.

Some popular solutions implementing the economy of sharing have been well known for at least the last several years. The first well developed aspect is the accommodation sharing where companies like Airbnb let users in more than 30 000 cities rent their private lodgings. Another popular economic sector with a developing sharing economy is the transport where companies like Uber connect users in order to establish ride sharing system as a substitute for public transportation and taxi services.

One of economic segments with less developed sharing economy but huge potential is the home and work electrical appliance industry. Some appliances only serve a specific purpose and are acquired by customers in order to perform a certain task. Once the task is completed the appliance is stored as idle capital and not only does its owner not profit from it but its value also depreciates with time. A good example for such appliance is thee common construction equipment. A user will most often buy an electric saw or a drill and immediately use it in a certain construction or repair. After that the appliance is stored and kept idle although it is capable to work much more before it eventually breaks. Another user may also need an electric saw and instead of buying one he could user the electric saw of the first user and even pay him a price for the service. The first user benefits from the fact that he makes profit from an underutilized asset and the second user benefits from the difference between the purchase and the rent price of the appliance.

The problem with this example is that in order for it to work the second user must know that the first user owns an underutilized appliance and the first user must respectively know that the second user needs such appliance. An information environment is necessary where users can act as lessors or lessees and register their idle electrical appliances. Such environment must have an implemented taxonomy of appliances and contain data for the type, condition, price and location of the appliance and whether it is currently available for sharing or used by a user.

Modern technologies make the implementation of such a system possible and easy to user. Many companies have created and maintain peer-to-peer online marketplaces in the form of web based platforms which are easily accessible by users through their personal computers and mobile devices. Such systems have become widely popular in many different areas like crowdfunding (Kickstarter and Indiegogo) and education (Udemy, EdX). Utilizing the resources of the information technologies is the key to creating a working appliance sharing network.

Most attempts for currency rating have been associated with comparing the value of one currency to the value of another one. For example 1 unit of gold may be considered 10 times more valuable than 1 unit of silver. And 1 unit of silver respectively may be considered 10 times more valuable than 1 unit of copper. These three basic types of metal currency (gold, silver and copper) can all circulate in the same payment system but have an assigned rating.

US Patent Documents:

Application Ser. No. 14/250,183, Sep. 4, 2014;

Application Ser. No. 14/337,153, Nov. 13, 2014

### SUMMARY

This section explains how the invention overcomes the problems pointed out in the background. A method for implementing a sharing economy for electrical appliances in an information environment is provided which makes it available for users to register their underutilized electrical appliance and lease them to other users.

The system contains data for user and electrical appliances. Each user provides information for his identity, contact information and financial information (billing and payment data). A user also has information for all the electrical appliances which he has registered in the system and a rating assigned to him through processing the feedback given by other users.

Each appliance in the system has data associate with it for its type, condition, location, owner, holder, price, rating and status. The type of the appliance is selected by the user acting as owner from a predefined taxonomy of electrical appliances. For example a user can register a cordless electric circular saw with a blade diameter of 285 mm equipped with blades for wood cutting. The condition of the appliance refers to whether it is a new one, a used one or a damaged one. This section is also filled by the owner and may contain valuable information for known problems with the appliance and specific operation requirements. The location of the device is best obtained through GPS tracking chips but it is also possible that this information is provided by the current holder of the appliance. The owner data refers to the user who is registered as owner of the device while the holder data refers to the user who currently holds the device even if not using it under a lease agreement. The price of the appliance is set by the owner and it's a lease price for a period of time. The rating of the appliance is provided by the users acting as lessees. The status shows if the appliance is currently available for sharing or not.

The data for users and appliances is stored in a database which is coupled to a server. The server is used for the operation of the systems. It handles action requests from users and transfers data through the web environment in order for users to interact with each other.

When a user decides to offer his appliance for sharing he must equip it with a GPS tracking chip. This chip provides real time data for the location of the appliance. When another wants to use the appliance he notifies the owner through the server with a lease application. In order for a lease agreement to be concluded the owner must confirm the request of the applicant. Once both parties have agreed to lease the appliance its status is set to unavailable indicating that the appliance is currently in use and cannot be shared. The holder parameter of the appliance now refers to the lessee.

When the lessee has finished using the appliance he does not have to physically return it to the owner. He just sets the status from unavailable to available indicating that he has finished using it and it can be shared again. The owner can collect the appliance or leave it to be stored by the holder. The server measures the period of time from the beginning of the lease to the moment when the status is changed by the holder and determines the price due. Additionally an automatic payment procedure may be implemented based on direct debit through the payment and billing information provided by the users.

After the lease both users are entitled to assign a rating for each other and the lessee can also assign a rating to the appliance. The rating of a user as a lessor or a lessee and the rating of the appliance equals the average of all ratings provided for the respective user or appliance.

When all the data for a multitude of appliances is available they can be ranked in a number of ways according to all of the data parameters. For example a user may want to search for electric circular chain saws in range of 5 miles from his location which cost no more than 5 dollars per day and have a rating of at least 8/10. All the data is stored in a database coupled to the server but the processed data is also published to a cloud environment and made accessible to the users of the system.

After the lease the owner can collect the appliance and set the holder status to refer to him once again or let the holder store it. In the latter case when another user wants to use the appliance he has to take it from the holder. Thus in order for the server to alter the holder status of the appliance the owner, the holder and the applicant must confirm this action.

The system and method will entitle users to easily share their underutilized assets on a peer-to-peer basis. It will also automatically collect, store and process metadata for the lease agreements executed by the users. If a payment module is also implemented in the system it will enable users to also pay the lease price in the system. The feedback provided by the users processed as rating of users and appliances will provide valuable information on which users are reliable and which not. It will also allow users to check if it is worth leasing a certain appliance for the listed price.

### BRIEF DESCRIPTION OF DRAWINGS

FIG. 1 illustrates the interactions between lessors and lessees in the system and how they interact with the server and the appliance cloud.

FIG. 2 represents the data stored in the system for users and appliances.

FIG. 3 depicts the process of obtaining user related data.

FIG. 4 depicts the process of obtaining appliance related data.

FIG. 5.1 shows the process of lease of appliance from the owner.

FIG. 5.2 shows the process of lease of appliance from the holder, which is a user different from the owner.

FIG. 6 illustrates as a block scheme the leasing process.

FIG. 7 represents the method for ending the lease agreements.

FIG. 8 depicts the process of data manipulation by the server upon execution of appliance leasing.

### DETAILED DESCRIPTION

An exemplary embodiment, as described below, may be used to provide a system and method for implementing the sharing economy in a web environment for collaborative use of mobile electric appliances.

### Interactions in the System

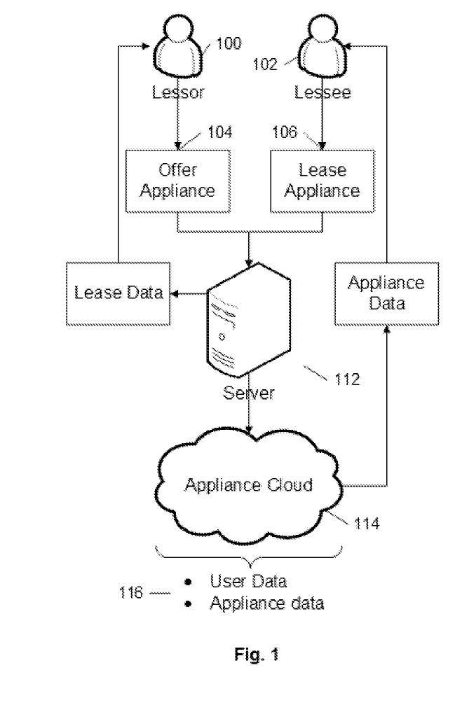

The structure of the system will be explained with reference to FIG. 1. All participants in the systems are connected through a network, like the Internet. Interactions and actions in the system happen on the initiative of the users but are executed by a server (112) used for operating the system. The server can also be a multitude of servers connected together. Users connect to the system through data processing devices, capable of sending and receiving data over the network and visualizing an interface for user interaction and notification. Users in the system can act as lessor and lessees where a lessor (100) is a user who wants to offer an electrical appliance that he owns for sharing at a certain price. The lessee (102) on the other hand is a user who is willing to use this appliance and pay the price. Regarding just a single electrical appliance a user can only act as a lessor or a lessee but with a multitude of appliances a user can be treated both as lessor and lessee. The lessor (100) registers his appliance by sending an offer (104) to the server (112). The server processes the data in the offer and publishes the information in a cloud environment, accessible to all users in the system (114). The appliance cloud contains data for all electrical appliances registered in the system and all users of the system. The type of data collected for users and appliances and the methods for collecting and processing will be explained further below.

Once an appliance is registered for sharing it can now be examined by a potential lessee (102) in the appliance cloud by checking the appliance data (110). If the user wants to use the appliance he sends a lease application (106) to the server (112). The server processes the application and sends a notification the lessor (100). If a lease agreement is concluded the server will start collecting metadata for the lease. This data (108) will be collected during the time when the lessee uses the appliances. Once the lease is over the data will be processed and made available to both the lessor and the lessee. The lease data (108) consists mainly of the total time of usage and the total price due.

### User and Appliance Data

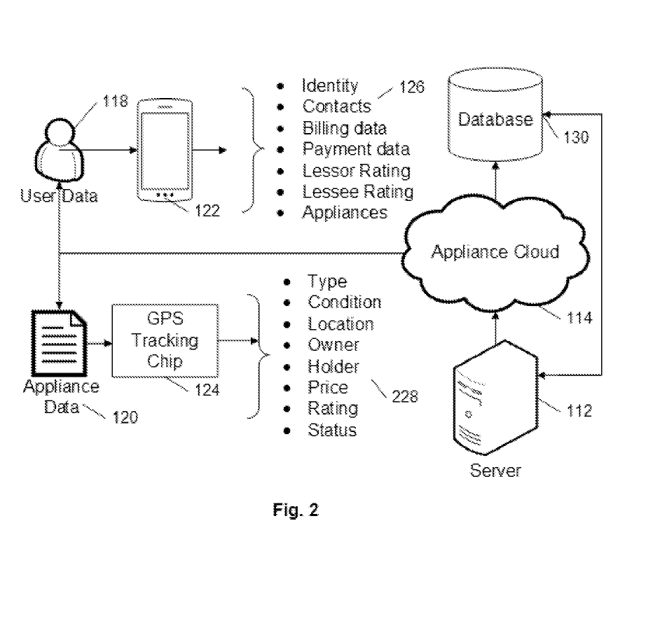

The data provided, collected and processed in the system will be explained with reference to FIG. 2. In FIG. 2 the data is divided in two—user data and appliance data. User data (118) is provided by the user to whom the information relates through his data processing device, for example a smart phone (122) as depicted in FIG. 2. The user data consists of the following parameters (126): identity, contacts, billing data, payment data, rating, appliances. Identity data refers to the real private data for the user as a person. Actual private data related to each user is important given the fact that users in the system are involved in contractual relationships when sharing the appliances. The contacts data refers to the ways of contacting the user regarding his activity in the system. It may consist of all means of communication like telephone number, e-mail and correspondence address. Billing data refers to the means of payment selected by the user for paying leasing process for appliances that he uses. For example it may be a bank account for direct debit by the system or a paypal account or even an account in the system with prepaid access. The payment data contains information for the preferred means of payment selected by the user for receiving the price of the appliances which he leases in the system. The payment data can be the same as the billing data but it can also differ since a user may prefer different means of payment. The user also has a user rating assigned to him by the server. The rating is divided in two—lessor rating and lessee rating. The rating is calculated by the server through processing all the ratings given to the users by other users who have participated in lease agreements with him. Users who have used some of the appliances of the rated user provide his lessor rating and users whose appliances have been used by the rated users provide his lessee data. The final data parameter which is related to the user contains a list of the appliances he has registered for sharing in the network with the corresponding appliance data. The data regarding the first four data parameters (identity, contacts, payment and billing) is provided by the user upon registration in the system. The user rating is assigned by the system through the processing of the feedback provided by other users. The appliance data is also generated by automatically by the server when the user registers a new appliance.

The appliance data (120) also consists of different data parameters (228): type, condition, location, owner, holder, price, rating and status. The type is selected from a taxonomy of appliances implemented in the network. For example a user can register a cordless electric circular saw with a blade diameter of 285 mm equipped with blades for wood cutting. The condition of the appliance refers generally to its state, specific instructions for operation and other data provided by the user. The electric saw from the previous example for instance may be a used saw with a battery life of one hour. The location of the appliance is dynamic data parameter which takes the GPS location data of the appliance. The GPS data is retrieved from a GPS tracking chip (124) which has to be installed on the appliance in order for it to be registered in the system. The chip transmits real time location data which is processed by the server. The owner and holder parameters refer respectively to the user who owns the appliance and the user who holds it in the current moment. Of course this can be the same user since the owner may also be in possession of the appliances but the holder will often be a different user. The price of the device is selected by the owner. It's a price for use over a preset period of time, for example 5 dollars per day. The rating of the appliance is assigned by the server through processing the feedback given by lessees. The final parameter is the status. It shows whether the appliance is available for sharing or not. It can either be set by the users of the system or automatically by the server at the start and end of lease agreements.

The user data (118) and the appliance data (120) are stored in a database (130) coupled to the server. This raw data is processed by the server (112) and published in the appliance cloud (114) where it is made accessible to the users.

### User Data Collection

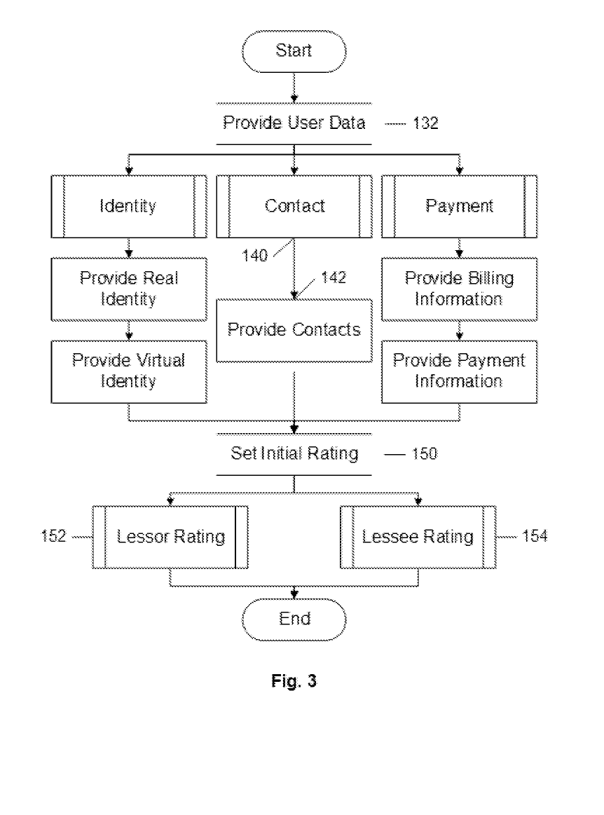

The process of collecting user data will be described with reference to FIG. 3. The process starts with data provided by the user (132) upon registration. Three sub-processes are executed simultaneously. The user provides his identity data (134) which consists of private data (136) and virtual identity data (138), like a username, password, etc. The virtual identity of the user is associated with his real identity. The private data is only revealed to users who have entered in contractual relation with the user. The user also provides contact information (140) which consists of the preferred means of contact (142)—a telephone number, an e-mail address, etc. The user must provide payment data (144) which consist of billing (146) and payment (148) information which as explained above can be the same.

After the initial data is provided by the user the server automatically assigns a neutral initial rating of the user (150). This refers to both his lessor rating (152) and his lessee rating (154). The data related to the appliances registered by the user is retrieved later.

### Appliance Data Collection

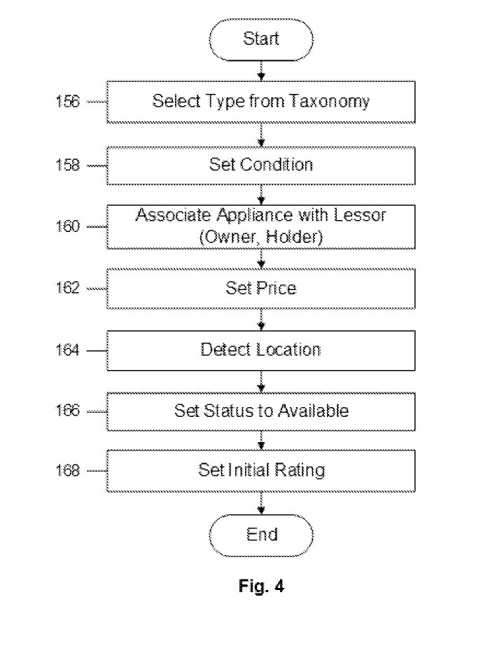

The process of collecting appliance data will be explained with reference to FIG. 4. When a user registers an appliance in the system he must first provide initial data for it. The first step is to select the type of the appliance from the appliance taxonomy in the system (156). After the type is selected the user must provide information about the condition of the appliance (158). This information may consist of anything that the user finds important. After this data is provided the server automatically sets the holder and owner parameters of the appliance. The owner parameter will always refer to the user who has registered it while the holder parameter will only initially refer to that user (160). The user must also set a lease price for the appliance (162) and associate the GPS tracking chip data with device (164). After the user has selected which tracking chip is installed on the appliance the server obtains its GPS location (164). The status of the appliance is initially set to available (166) and the rating is set to neutral (168).

Leasing from Owner and from Holder

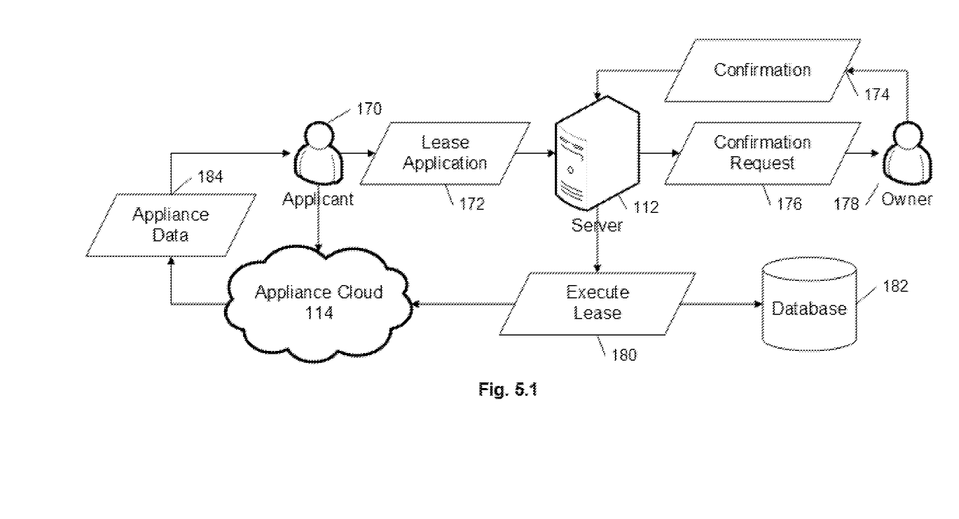

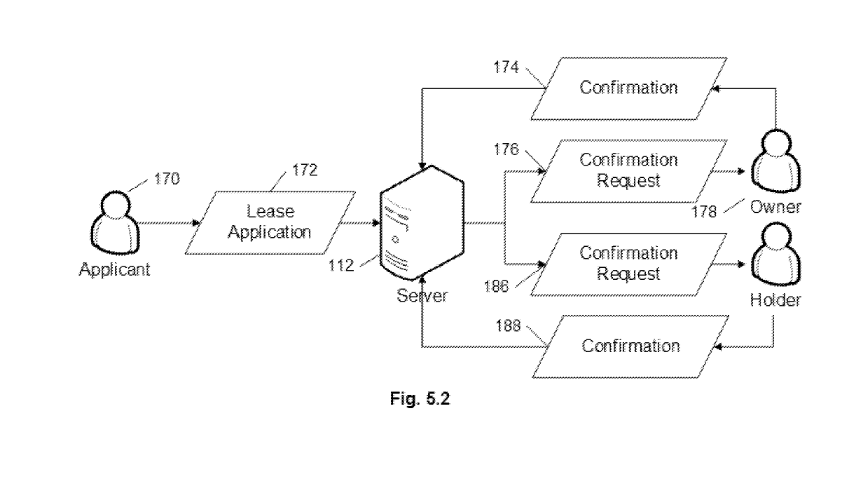

Two types of sharing processes are available in the system—leasing an item directly from the owner or leasing from the holder which is a different user than the owner. These processes will be explained with reference to FIG. 5.1 and FIG. 5.2.

FIG. 5.1 depicts the process of leasing an appliance from the owner. A user (170) wants to use a device registered for sharing. He has already checked the appliance data (184) from the appliance cloud and now has to request a confirmation from the owner. In order to do so he must send a lease application (172) to the server (112). The server processes the application and sends a notice and confirmation request (176) to the user, who is referred to as owner (178) in the appliance owner data parameter. The owner is than given access to the data of the applicant and can either confirm the lease or refuse it. When a confirmation (174) is sent to the server it executes the lease (180) by altering the respective data parameters of the appliance as will be explained further below. The new data parameters are also published in the appliance cloud (114). The server also starts collecting raw data for the lease in the database (182). This data refers to the initial and end time of the lease.

The process is different when the appliance which the applicant wants to use is currently in possession of user, different than the owner. The specifics of this process will be described with reference to FIG. 5.2. When a user wants to wants to use an appliance which is not held by the owner he must also receive a confirmation by the holder. The process once again starts with a lease application (172) sent by the user (170) to the server (112). The server processes the application and established that the owner of the appliance is different from the holder of the appliance. The server again sends a confirmation request (176) to the owner (178) but it also sends another confirmation request (186) to the holder (190). If a conformation from the owner (174) and a confirmation from the holder (188) are received the server executes the lease agreement.

### Sharing Process

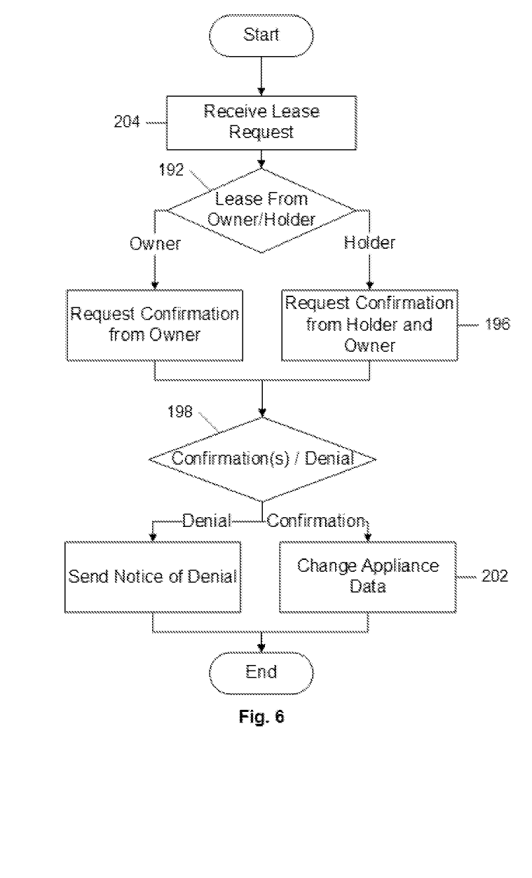

FIG. 6 illustrates the sharing process as a flow chart. The process starts with a lease request (204) sent from an applicant to the server. The server than establishes if the owner of the appliance is the same user as its holder (192) through comparing the holder and owner parameters of the appliance in the database. If the appliance is in possession of the owner the server sends him a confirmation request (194). Otherwise a confirmation request is sent to both the owner and the holder of the appliance (196). The server than waits for confirmation or denial (198) from the respective users. If a confirmation is sent the server changes the appliance data in the database and the appliance cloud (202). If a denial is received rather than a confirmation the server sends a notice of denial (200) to the applicant.

### End of Lease

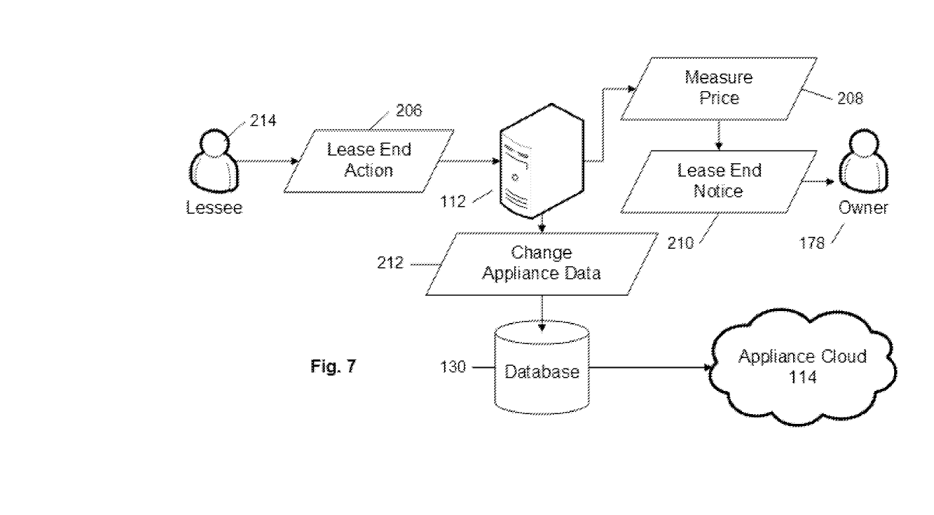

When a lease process has started and the lessee no longer wants to use the appliance a certain process must be executed in order to end the lease. This process will be explained with reference to FIG. 7. When a lessee (214) is done using the appliance he must offer it for sharing in the appliance cloud once again. In order to do this the lessee sends a notice to the server (206) indicating the end of the lease. The server (112) then measures the price due for the time the lessee has been using the appliance (208). The price is calculated through the processing of the metadata collected during the lease period. After that the server sends a lease end notice (210) to the owner (178). This notice contains an indication that the appliance is now available for collecting or further sharing and the price which the lessee owns for the use of the appliance.

The server also changes the data parameters of the appliance (212) in the database (130) and the appliance cloud environment (114) as will be explained in the next paragraph.

### Data Manipulation

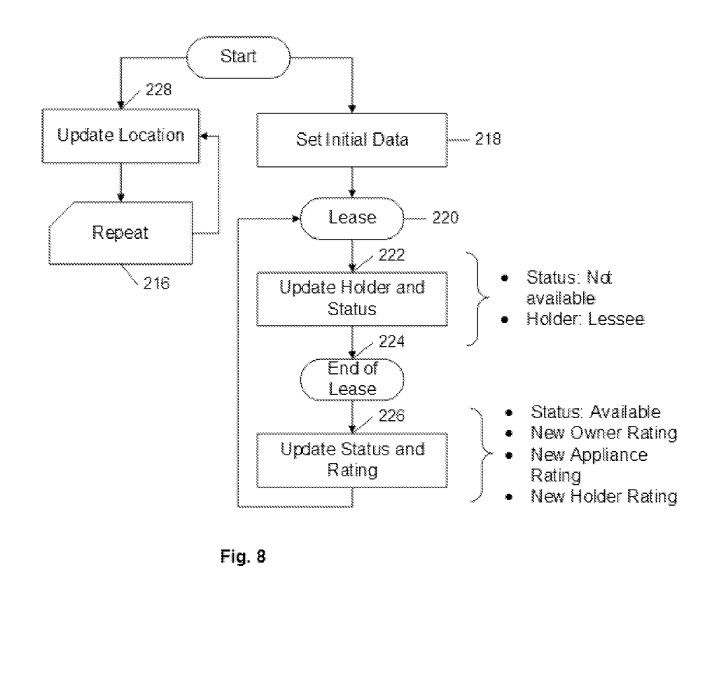

FIG. 8 depicts the process of data manipulation performed by the server upon certain events in the system. When an appliance is registered the server starts to periodically receive data transmitted by the GPS tracking chip in order to maintain an actual location data of the appliance. When actual data is received from the chip the server updates the location parameter (228) with the GPS coordinates of the appliance. This procedure is repeated (216) each time the server receives data from the tracking chip associated with the appliance.

As was explained above upon registration of an appliance initial data is provided or set automatically (218). The user registering the device provides the type, condition and price data parameters of the appliance while the server sets the owner, holder, rating and status parameters. When a lease agreement (220) is concluded for a certain appliance the server updates the holder parameter ad the status parameter of the appliance (222). The holder parameter now refers to the lessee and the status is set to not available indicating that the appliance is currently not available for sharing. When the lease ends (224) the server updates the status and rating parameters (226). The status of the appliance is set to available while the ratings of the appliance, the holder and the owner are updated once feedback is provided from the respective user. The lessee provides rating for the appliance and the owner and the owner provides rating for the lessee.

While the contents of the present disclosure have been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this invention, but that the disclosure will include all embodiments falling within the scope of the appended claims.

The foregoing description of a preferred embodiment of the disclosure has been presented for purposes of illustration and description. It is not intended to be exhaustive or to limit the disclosure to the precise form disclosed. Obvious modifications or variations are possible in light of the above teachings. The embodiment was chosen and described to provide the best illustration of the principles of the disclosure and its practical application to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally and equitably entitled.

1. A system for implementation of sharing economy for electrical appliances in a web environment, the system comprising:
a) a multitude of data processing devices capable of sending and receiving data over the network and visualizing an interface for interacting with other users and a server;
(b) a least one device—a server, capable of sending, receiving and handling data over the network;
(c) a database used for storing raw data for users and appliances in the network;
(d) a cloud environment containing processed data by the server from the server made accessible to the users over the network and containing data for user and appliances, where each user entry comprises at least:
1) private user data provided by the user including identity and contacts;
2) payment and billing data for the user provided by the user;
3) rating as lessor and lessee of appliances in the system where lessor rating is provided by the users who have used the appliances share by the rated user and the lessee rating being provided by the users from whom the rated user has borrowed appliances;
and each appliance entry comprising:
1) type of the appliance selected upon its registration in the system from a predefined taxonomy of electrical appliances;
2) condition of the appliance referring to whether the appliance is new or used and containing all necessary information for the way it is supposed to function provided by its owner;
3) GPS based location data retrieved from a GPS tracking chip installed on the device and associated with it in the system;
4) reference to owner and current holder where the owner parameter refers to the user who has registered the appliance and the holder parameter refers to the user who is currently in possession of the appliance;
5) price per use selected by the owner upon registration;
6) status indicating whether the appliance is currently available for sharing;
7) rating provided by users who have used the appliance.

2. The system of claim 1 wherein users are identified through a biometric identification procedure.

3. A method for implementing an economy of sharing for electrical appliances in a network environment, comprising:
a) a procedure for registering electrical appliances in a cloud environment including:
1) registering a user in a cloud environment by receiving from the user real and virtual identity data including private data and payment data;
2) the user registering a device for sharing by selecting initial data for an electrical appliance including type, condition, location and price per use of the appliance;
3) the data being stored in a database, processed by a server and published in a cloud environment where it is made accessible to other users of the system;
b) a procedure for sharing electrical appliances in the cloud environment including:
1) a user sending a lease application to the server regarding a certain appliance in the database;
2) the server establishing if the user who has registered the appliance and the person who holds the appliance are the same user;
3) the server sending confirmation request(s) to the user(s);
4) the user(s) sending confirmation(s) to the server for the lease;
5) the server changing the status of the appliance from available to not available for sharing;
6) upon end of the lease the user acting as lessee sending a notice to the server to change the status of the appliance to available indicating that he has finished using it.

4. The method of claim 3 where the server extracts metadata for lease agreements concluded in the system for at least initial and end time of the least and price due for the lease period where the price is calculated through processing data for the prices per use set by the owner of the appliance and the time during which it has been used by the lessee.

5. The method of claim 3 where electrical appliances are coupled with GPS tracking chips sending real time GPS location data for the appliance; the data being processed by the server and published in the cloud environment as a data parameter for a certain device;

6. The method of claim 3 where private data of the users is not published in the cloud environment but only revealed among users who have entered into at least lease negotiations in the system;

7. The method of claim 2 where upon conclusion of a lease agreement the users are entitled to provide feedback for both the appliance and the respective user acting as the counterparty where the lessee is entitled to rate the owner and the appliance and lessor is entitled to rate the lessee;

8. The method of claim 2 where users can browse the cloud environment for electrical appliances by setting different filters or a combination of filters based on data parameters of the appliances, comprising at least location data, type and price per use of the appliance.
